(19) United States
(12) Patent Application Publication
(10) Pub. No.: US 2026/0357042 A1
(43) Pub. Date: Nov. 12, 2026

(54) FIBER REINFORCED THERMOPLASTIC POLYMER COMPOSITION

(71) Applicant: SABIC GLOBAL TECHNOLOGIES B.V., Bergen op Zoom (NL)

(72) Inventors: Rob DONNERS, Brunssum (NL); Gerard Jan Eduard BIEMOND, Brunssum (NL)

(21) Appl. No.: 19/515,144

(22) PCT Filed: Aug. 22, 2024
(86) PCT No.: PCT/EP2024/073552

§ 371 Date: Feb. 27, 2026

(30) Foreign Application Priority Data
Sep. 1, 2023 (EP) 23194854.8

(51) Int. Cl. C08K 9/08; C08L 23/12

(52) U.S. Cl. CPC C08K 9/08; C08L 23/12; C08K 2201/004; C08L 2201/02

(57) ABSTRACT

A pellet including a fiber reinforced thermoplastic polymer composition including a thermoplastic polymer and a plurality of co-filaments, wherein each of the co-filaments includes a first filament and a second filament, the first filament consisting of an inorganic material, the first filament having a glass transition temperature of greater than or equal to 400 °C, the second filament consisting of a metallic material, and the second filament contacting the first filament,
wherein the weight average length of the co-filaments in the pellet is at least 5.0 mm.

### CROSS REFERENCE TO RELATED APPLICATIONS

This application is a National Stage Application of PCT/EP2024/073552, filed Aug. 22, 2024, which claims the benefit of European Application No. 23194854.8, filed Sep. 1, 2023, both of which are incorporated by reference in their entirety herein.

### BACKGROUND

The present invention relates to a pellet comprising a fiber reinforced thermoplastic polymer composition and a process for producing such pellet. The present invention further relates to a molded article made from such pellet.

A fiber reinforced thermoplastic polymer composition in which a thermoplastic polymer is reinforced by glass fibers is widely used. The glass fibers may be chopped before being melt-mixed with the thermoplastic polymer to be dispersed therein. Alternatively, the glass fibers may be combined with the thermoplastic polymer as long glass fibers without chopping.

Fiber reinforced thermoplastic compositions having high electromagnetic/radio frequency interference (EMI/RFI) shielding effectiveness by the use of conductive fibers are known. For example, U.S. Pat. No. 4,566,990 discloses a thermoplastic polymeric composition having high electromagnetic interference shielding effectiveness comprising a thermoplastic resin or resin blend, metal flake, and metal or metal coated fiber.

US20170001336A1 discloses a fiber-reinforced multilayered pellet comprising a sheath layer; and a core layer, the sheath layer comprising a resin composition comprising a thermoplastic resin (a1) and a fibrous filler (b1), wherein the fibrous filler (b1) has a weight-average fiber length (Lw) of 0.1 mm to less than 0.5 mm and a weight-average fiber length/number-average fiber length ratio (Lw/Ln) of 1.0 to less than 1.8, the core layer comprising a resin composition comprising a thermoplastic resin (a2) and a fibrous filler (b2), wherein the fibrous filler (b2) has a weight-average fiber length (Lw) of 0.5 mm to less than 15.0 mm and a weight-average fiber length/number-average fiber length ratio (Lw/Ln) of 1.8 to less than 5.0.

US2010068518 discloses a molding material comprising: (i) 1 to 50% by weight of a bundle of continuous reinforcing fibers (A); (ii) 0.1 to 10% by weight of a polyarylene sulfide prepolymer (B) comprising at least 50% by weight of cyclic polyarylene sulfide and having a weight average molecular weight of less than 10,000 or polyarylene sulfide (B′) having a weight average molecular weight of 10,000 or greater and having the degree of dispersion represented by weight average molecular weight/number average molecular weight of 2.5 or smaller; and (iii) 40 to 98.9% by weight of a thermoplastic resin (C), wherein component (C) is adhered to a composite of component (A) and component (B) or (B′).

U.S. Pat. No. 5,935,508A discloses a process for the manufacture of fibre-reinforced intermediates useful in thermoplastic processing methods, which comprises impregnating continuous fibres with a resin composition comprising at least one radiation-polymerisable component; exposing the impregnated fibres to radiation to effect polymerisation of such component; and cutting the product to form thermoplastically processible intermediates.

It is an objective of the present invention to provide a pellet which can be used for making a molded article having a high EMI shielding property.

### SUMMARY

Accordingly, the present invention provides a pellet comprising a fiber reinforced thermoplastic polymer composition comprising a thermoplastic polymer and a plurality of co-filaments,
wherein each of the co-filaments comprises a first filament and a second filament, the first filament consisting of an inorganic material, the first filament having a glass transition temperature of greater than or equal to 400 °C, the second filament consisting of a metallic material, and the second filament contacting the first filament,
wherein the weight average length of the co-filaments in the pellet is at least 5.0 mm.

The pellet comprises or consists of the fiber reinforced thermoplastic polymer composition.

### DETAILED DESCRIPTION

The co-filaments used in the present invention have a high shielding property against electromagnetic waves. The present inventors have realized that the relatively large average length of the co-filaments in the pellet according to the invention allows, in a molded article made from the pellets according to the invention, the co-filaments to be close to each other to form a network for improving the EMI shielding property.

The co-filaments may be present in the pellet according to the invention as bundled co-filaments or may be dispersed in the pellet. Generally, a pellet comprising bundled co-filaments can be obtained by the so-called wire-coating process, and a pellet comprising dispersed co-filaments can be obtained by the so-called pultrusion process, explained herein in detail.

The filaments in the pellet may consist of the co-filaments. Alternatively, the filaments in the pellet may further comprise glass filaments. The presence of the glass filaments may be beneficial for production cost and/or mechanical properties of the molded article made from the pellets.

The weight ratio between the co-filaments and the glass filaments in the pellet may be any ratio, for example 10:90 to 90:10, for example 10:90 to 50:50 or 50:50 to 90:10. The weight ratio may be selected based on the desired EMI shielding property and the cost and mechanical properties.

### Sheathed Continuous Multifilament Strand

In one aspect, the invention provides a pellet comprising a sheathed continuous multifilament strand comprising a core that extends in the longitudinal direction and a polymer sheath which intimately surrounds said core,
wherein the core comprises an impregnated continuous bicomponent multifilament strand comprising at least one continuous bicomponent multifilament strand comprising the plurality of co-filaments which are bundled and
the polymer sheath consists of a thermoplastic polymer composition comprising the thermoplastic polymer.

Preferably, the pellet consists of the sheathed continuous multifilament strand.

The core-sheath structure of such sheathed continuous multifilament strand is per se known and is described in detail e.g. in WO2009/080281, incorporated herein by reference.

The invention also provides a process for preparing the pellet according to the invention, comprising the sequential steps of:
a) unwinding from a package of the at least one continuous bicomponent multifilament strand,
b) applying an impregnating agent to said at least one continuous bicomponent multifilament strand to form the impregnated continuous bicomponent multifilament strand,
c) applying a sheath of the thermoplastic polymer composition around the impregnated continuous bicomponent multifilament strand to form the sheathed continuous multifilament strand and
d) cutting the sheathed continuous multifilament strand into pellets.

Preferably, the weight average length of the co-filaments in the pellet is substantially the same as the pellet length, and preferably is 10 to 55 mm, preferably 10 to 40 mm, more preferably 10 to 30 mm and most preferably from 10 to 20 mm.

The core may comprise an impregnated continuous bicomponent multifilament strand comprising at least one continuous bicomponent multifilament strand and an impregnated continuous glass multifilament strand comprising at least one continuous glass multifilament strand.

When the filaments in the pellet further comprise glass filaments, the pellet may be prepared by a process comprising the steps of:
a) unwinding from a package of the at least one continuous bicomponent multifilament strand,
a2) unwinding from a package of at least one continuous glass multifilament strand,
b) applying an impregnating agent to said at least one continuous bicomponent multifilament strand to form the impregnated continuous bicomponent multifilament strand,
b2) applying an impregnating agent to said at least one continuous glass multifilament strand to form an impregnated continuous glass multifilament strand,
c′) applying a sheath of thermoplastic polymer around the impregnated continuous bicomponent multifilament strand and the impregnated continuous glass multifilament strand to form the sheathed continuous multifilament strand and
d) cutting the strand into the pellets.

The order of steps to be performed is a) and a2), then b and b2), then c′) and then d).

Steps a) and a2) can be performed in any order.

Steps b) and b2) may be performed as separate steps, but are preferably performed as one step of applying an impregnating agent to said at least one continuous bicomponent multifilament strand and said at least one continuous glass multifilament strand to form the impregnated continuous bicomponent multifilament strand and the impregnated continuous glass multifilament strand.

Composition with Dispersed Co-Filaments

In one aspect, the invention provides a pellet wherein the plurality of co-filaments are dispersed in a matrix of the thermoplastic polymer.

Suitable examples of the thermoplastic polymer of the matrix of the pellet are those described herein as examples of the thermoplastic polymer in the thermoplastic polymer composition of the polymer sheath of the sheathed continuous multifilament strand.

The pellet may further comprise additives. Suitable examples of the additives are those described herein as examples of the additives in the thermoplastic polymer composition of the polymer sheath of the sheathed continuous multifilament strand.

Such pellet can be obtained e.g. by a pultrusion method as described in U.S. Pat. No. 6,291,064B1, hereby incorporated by reference.

The invention also provides a process for preparing the pellet according to the invention, comprising the sequential steps of:
i) unwinding from a package of the at least one continuous bicomponent multifilament strand,
ii) spreading the at least one continuous bicomponent multifilament strand into individual co-filaments,
iii) drawing the co-filaments through a melt of a thermoplastic polymer composition comprising the thermoplastic polymer to impregnate the co-filaments with the thermoplastic polymer to obtain a strand wherein the co-filaments are dispersed in the matrix of the thermoplastic polymer, and
iv) cutting the strand to obtain pellets.

Preferably, the weight average length of the filaments in the pellet is substantially the same as the pellet length, and is preferably 5.0 to 10 mm, preferably 5.0 to 8.0 mm.

When the filaments in the pellet further comprise glass filaments, the pellet may be prepared by a process comprising the steps of:

i) unwinding from a package of the at least one continuous bicomponent multifilament strand,
i2) unwinding from a package of at least one continuous glass multifilament strand,
ii) spreading the at least one continuous bicomponent multifilament strand into individual co-filaments,
ii2) spreading the at least one continuous glass multifilament strand into individual glass filaments,
iii′) drawing the co-filaments and the glass filaments through a melt of a thermoplastic polymer composition comprising the thermoplastic polymer to impregnate the co-filaments and the glass filaments with the thermoplastic polymer to obtain a strand wherein the co-filaments and the glass filaments are dispersed in the matrix of the thermoplastic polymer, and
iv) cutting the strand to obtain pellets.

The order of steps to be performed is i) and i2), then ii and ii2), then iii′) and then d).

Steps i) and i2) can be performed in any order.

Steps ii) and ii2) can be performed in any order.

### Molded Article

The molded article according to the invention is made by molding pellets comprising the pellets according to the invention. The pellets used for molding may consist of the pellets according to the invention. The pellets used for molding may further comprise other types of pellets in addition to the invention. For example, said other types of pellets may be pellets comprising a thermoplastic polymer and glass filaments or pellets of a thermoplastic polymer not comprising glass filaments. Suitable examples of such further polymer are those described herein as examples of the thermoplastic polymer in the thermoplastic polymer composition of the polymer sheath of the sheathed continuous multifilament strand.

Accordingly, the invention provides a molded article made by molding of the pellets according to the invention and optionally pellets of a thermoplastic composition comprising a thermoplastic polymer and optionally glass filaments.

The thermoplastic polymer in the optional pellets are preferably the same as the thermoplastic polymer in the pellet according to the invention and preferably is polypropylene.

The optional pellets not comprising glass filaments may be made by standard methods. The optional pellets comprising glass filaments are preferably pellets made by wire-coating process or pultrusion process.

In some embodiments, the optional pellet comprises a sheathed continuous multifilament strand comprising a core that extends in the longitudinal direction and a polymer sheath which intimately surrounds said core,
wherein the core comprises an impregnated continuous glass multifilament strand comprising at least one continuous glass multifilament strand and
the polymer sheath consists of a thermoplastic polymer composition comprising a thermoplastic polymer.

In some embodiments, the optional pellet comprises glass filaments dispersed in a matrix of a thermoplastic polymer.

Preferably, the optional pellets have the same structure as the pellets according to the invention, i.e. when the pellets according to the invention have the sheathed core structure, the optional pellets used in combination also have the sheathed core structure and when the pellets according to the invention have a structure in which filaments are dispersed in a matrix, the optional pellets used in combination also have such structure.

The amount of the pellets according to the invention with respect to the total pellets used for making the molded article may be 5 to 100 wt %, for example 5 to 50 wt % or 50 to 100 wt %.

Suitable examples of molding processes include injection molding, compression molding, extrusion (optionally followed by thermoforming) and extrusion compression molding.

In some particularly preferred embodiments, the molded article is an injection molded article. Preferably, the weight average length of the co-filaments in the article is at least 1.0 mm, preferably 1.0 to 2.0 mm, for example 1.3 to 1.7 mm.

In some particularly preferred embodiments, the molded article is an extrusion molded article. Preferably, the weight average length of the co-filaments in the article is at least 0.5 mm, preferably at least 1.0 mm, preferably 1.0 to 2.0 mm, for example 1.3 to 1.7 mm. The type of equipment used for extrusion has an effect on the weight average length of the co-filaments in the article. Use of a single screw extruder generally results in a longer weight average length of the co-filaments than a double screw extruder.

The molded article may preferably be selected from the group consisting of battery housing, battery tray, battery charging station, power tools, building and construction shielding boxes, scaffolding, construction frames and flooring.

### Co-Filament

The co-filament in the pellet of the invention is described in detail in WO2022156922A1, incorporated herein by reference.

Each of the co-filaments comprises a first filament and a second filament, the first filament consisting of an inorganic material, the first filament having a glass transition temperature of greater than or equal to 400 °C, the second filament consisting of a metallic material, and the second filament contacting the first filament. The co-filament preferably consists of the first filament and the second filament.

An “inorganic material” is understood to mean a material that contains no plant or animal components or has them only to a lesser extent as impurities. An inorganic material may be a natural stone, in particular granite, basalt, slate, sandstone or limestone. An inorganic material is preferably understood to mean a material which contains little or no carbon as an impurity. An inorganic material may be a ceramic, a glass (a crystalline glass or an amorphous glass), in particular an E glass, an S glass or a C glass.

The “glass transition temperature” of a material, in particular a glass, a polymer or a ceramic, describes the temperature at which the material changes from its solid state to a viscous or liquid state.

Particularly preferably, the first filament is a glass filament or a basalt filament.

A “metallic material” is understood to mean a substance that is located specifically to the left and below a dividing line from boron to astatine in the periodic table of the elements.

Particularly preferably, the second filament has an aluminum content of at least 98 wt %, at least 99 wt % or at least 99.5 wt % or a copper content of at least 98 wt %, at least 99 wt % or at least 99.5 wt %.

A “co-filament” describes a filament with a practically endless length, which has at least two partial filaments of different material properties extending in the longitudinal direction, wherein the two materially different filaments are physically and/or chemically connected to one another to form the co-filament. A co-filament may have a ratio of length to diameter of greater than or equal to 1000.

Preferably, the first filament and the second filament are physically and/or chemically connected to one another to form the co-filament and a contact region between the first filament and the second filament is at least 5% of the circumference of the first filament.

Preferably, a contact area between the first filament and the second filament is 5 to 95%, more preferably 10 to 90%, more preferably 15 to 85%, of the circumference of the first filament.

### Details of Sheathed Continuous Multifilament Strand

The pellet comprising the sheathed continuous multifilament strand according to the invention has an advantage that its manufacturing process can be performed at higher speed than the pultrusion process and that materials with low MFI can be used.

The pellet comprises or consists of the sheathed continuous multifilament strand. The sheathed continuous multifilament strand comprises or consists of a core and a polymer sheath. The core has a generally cylindrical shape and comprises an impregnated continuous bicomponent multifilament strand comprising the co-filaments. The core is intimately surrounded around its circumference by a polymer sheath having a generally tubular shape and consisting of a thermoplastic polymer composition. The co-filaments have a length substantially equal to the axial length of the pellet.

The core does not substantially contain the material of the sheath. The sheath is substantially free of filaments. Such a pellet structure is obtainable by a wire-coating process such as for example disclosed in WO 2009/080281 and is distinct from the pellet structure that is obtained via the typical pultrusion type of processes such as disclosed in U.S. Pat. No. 6,291,064.

Preferably, the polymer sheath is substantially free of co-filaments, meaning it comprises less than 2 wt % of filaments based on the total weight of the polymer sheath.

Preferably, the radius of the core is between 800 and 4000 micrometer and/or the thickness of the polymer sheath is between 500 and 1500 micrometer.

Preferably, the core comprises between 35 and 60% of the cross section area of the pellet and the sheath comprises between 40 and 65% of the cross section area of the pellet.

In some embodiments, the core comprises between 3 and 35% of the cross section area of the sheathed continuous multifilament strand and the sheath comprises between 65 and 97% of the cross section area of the sheathed continuous multifilament strand. In some embodiments, the core comprises between 35 and 60% of the cross section area of the sheathed continuous multifilament strand and the sheath comprises between 40 and 65% of the cross section area of the sheathed continuous multifilament strand.

Preferably, the amount of the core is 10 to 80 wt %, for example 10 to 50 wt % (for example 25 to 45 wt %) or 50 to 80 wt % (for example 60 to 75 wt %), with respect to the sheathed continuous multifilament strand. Preferably, the amount of the sheath is 20 to 90 wt %, for example 20 to 50 wt % (for example 25 to 40 wt %) or 50 to 90 wt % (for example 55 to 75 wt %), with respect to the sheathed continuous multifilament strand. Preferably, the total amount of the core and the sheath is 100 wt % with respect to the sheathed continuous multifilament strand.

### Polymer Sheath

The sheath intimately surrounds the core. The term intimately surrounding as used herein is to be understood as meaning that the polymer sheath substantially entirely contacts the core. Said in another way the sheath is applied in such a manner onto the core that there is no deliberate gap between an inner surface of the sheath and the core containing the impregnated continuous multifilament strands. A skilled person will nevertheless understand that a certain small gap between the polymer sheath and the core may be formed as a result of process variations.

The polymer sheath consists of a thermoplastic polymer composition.

### Thermoplastic Polymer Composition of Polymer Sheath

The thermoplastic polymer composition comprises a thermoplastic polymer. Preferably, the thermoplastic polymer composition consists of the thermoplastic polymer and additives described below.

The thermoplastic polymer composition may have a melt flow index as measured according to ISO1133-1:2011 (2.16 kg/230 °C) of 1.0 to 150 dg/min, for example at least 1.0 dg/min and less than 20 dg/min, or 20 to 150 dg/min.

### Thermoplastic Polymer in Thermoplastic Polymer Composition of Polymer Sheath

The amount of the thermoplastic polymer with respect to the thermoplastic polymer composition may be at least 50 wt %, for example 50 to 99.9 wt %, 75 to 99.9 wt % or 95 to 99.9 wt %.

Suitable examples of thermoplastic polymers include but are not limited to polyamide, such as polyamide 6, polyamide, 66 or polyamide 46; polyolefins, for example polypropylenes and polyethylenes; polyesters, such as polyethylene terephthalate, polybutylene terephthalate; polycarbonates; polyphenylene sulphide; polyurethanes and and mixtures thereof.

The thermoplastic polymer is preferably a polyolefin, more preferably a polyolefin chosen from the group of polypropylenes or elastomers of ethylene and α-olefin comonomer having 4 to 8 carbon atoms, and any mixtures thereof.

In one embodiment, preferably the thermoplastic polymer composition comprises at least 80 wt % of the thermoplastic polymer, for example at least 90 wt %, at least 93 wt %, at least 95 wt %, at least 97 wt % at least 98 wt % or at least 99 wt % of the thermoplastic polymer based on the thermoplastic polymer composition. In a special embodiment, the thermoplastic polymer composition consists of the thermoplastic polymer. In another embodiment, the thermoplastic polymer composition comprises at least 60 wt %, for example at least 70 wt %, for example at least 75 wt % and/or at most 99 wt %, for example at most 95 wt %, for example at most 90 wt % of the thermoplastic polymer.

The thermoplastic polymer may have a melt flow index in the range from 1.0 to 150 dg/min as measured according to ISO1133-1:2011 (2.16 kg/230 °C). In some embodiments, the thermoplastic polymer has a melt flow index of at least 1.0 dg/min and less than 20 dg/min preferably 5.0 to 19 dg/min, more preferably 6.0 to 18 dg/min, as measured according to ISO1133-1:2011 (2.16 kg/230 °C). In some embodiments, the thermoplastic polymer has a melt flow index of 20 to 150 dg/min, for example in the range from 30 to 140 dg/min as measured according to ISO1133-1:2011 (2.16 kg/230 °C). Preferably, the thermoplastic polymer has a melt flow index in the range from 50 to 130 dg/min as measured according to ISO1133-1:2011 (2.16 kg/230 °C). This leads to good mechanical properties of the obtained composition.

The polypropylene may for example be a propylene homopolymer or a random propylene copolymer or a heterophasic propylene copolymer.

A propylene homopolymer can be obtained by polymerizing propylene under suitable polymerization conditions. A propylene copolymer can be obtained by copolymerizing propylene and one or more other α-olefins, preferably ethylene, under suitable polymerization conditions. The preparation of propylene homopolymers and copolymers is, for example, described in Moore, E. P. (1996) Polypropylene Handbook. Polymerization, Characterization, Properties, Processing, Applications, Hanser Publishers: New York.

The random propylene copolymer may comprise as the comonomer ethylene or an α-olefin chosen from the group of α-olefins having 4 to 10 C-atoms, preferably ethylene, 1-butene, 1-hexene or any mixtures thereof. The amount of the comonomer is preferably at most 10 wt % based on the random propylene copolymer, for example in the range from 2-7 wt % based on the random propylene copolymer.

Polypropylenes can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

Preferably, the heterophasic propylene copolymer is made using Ziegler-Natta catalyst.

The heterophasic propylene copolymer may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α olefin copolymer.

These steps are preferably performed in different reactors. The catalyst systems for the first step and for the second step may be different or same.

The heterophasic propylene copolymer of the composition consists of a propylene-based matrix and a dispersed ethylene-α-olefin copolymer. The propylene-based matrix typically forms the continuous phase in the heterophasic propylene copolymer. The amounts of the propylene-based matrix and the dispersed ethylene-α-olefin copolymer may be determined by ¹³C-NMR, as well known in the art.

The propylene-based matrix consists of a propylene homopolymer and/or a propylene copolymer consisting of at least 70 wt % of propylene monomer units and at most 30 wt % of comonomer units selected from ethylene monomer units and α-olefin monomer units having 4 to 10 carbon atoms, for example consisting of at least 80 wt % of propylene monomer units and at most 20 wt % of the comonomer units, at least 90 wt % of propylene monomer units and at most 10 wt % of the comonomer units or at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexen, 1-heptene and 1-octene, and is preferably ethylene.

Preferably, the propylene-based matrix consists of a propylene homopolymer.

The melt flow index (MFI) of the propylene-based matrix (before the heterophasic propylene copolymer is mixed into the composition), MFI_{PP}, may be for example at least 0.1 dg/min, at least 0.2 dg/min, at least 0.3 dg/min, at least 0.5 dg/min, at least 1 dg/min, at least 1.5 dg/min, and/or for example at most 50 dg/min, at most 40 dg/min, at most 30 dg/min, at most 25 dg/min, at most 20 dg/min, measured according to ISO1133 (2.16 kg/230 °C). The MFI_{PP} may be in the range of for example 0.1 to 50 dg/min, for example from 0.2 to 40 dg/min, for example 0.3 to 30 dg/min, for example 0.5 to 25 dg/min, for example from 1 to 20 dg/min, for example from 1.5 to 10 dg/min, measured according to ISO1133 (2.16 kg/230 °C).

The propylene-based matrix may e.g. be present in an amount of 50 to 95 wt %. Preferably, the propylene-based matrix is present in an amount of 60 to 85 wt %, for example at least 65 wt % or at least 70 wt % and/or at most 78 wt %, based on the total heterophasic propylene copolymer.

The propylene-based matrix is preferably semi-crystalline, that is it is not 100% amorphous, nor is it 100% crystalline. For example, the propylene-based matrix is at least 40% crystalline, for example at least 50%, for example at least 60% crystalline and/or for example at most 80% crystalline, for example at most 70% crystalline. For example, the propylene-based matrix has a crystallinity of 60 to 70%. For purpose of the invention, the degree of crystallinity of the propylene-based matrix is measured using differential scanning calorimetry (DSC) according to ISO11357-1 and ISO11357-3 of 1997, using a scan rate of 10 °C/min, a sample of 5 mg and the second heating curve using as a theoretical standard for a 100% crystalline material 207.1 J/g.

Besides the propylene-based matrix, the heterophasic propylene copolymer also comprises a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form. The particle size of the dispersed phase is typically in the range of 0.05 to 2.0 microns, as may be determined by transmission electron microscopy (TEM). The amount of the dispersed ethylene-α-olefin copolymer in the heterophasic propylene copolymer may herein be sometimes referred as RC.

The amount of ethylene monomer units in the ethylene-α-olefin copolymer may e.g. be 20 to 65 wt %. The amount of ethylene monomer units in the dispersed ethylene-α-olefin copolymer in the heterophasic propylene copolymer may herein be sometimes referred as RCC2.

The α-olefin in the ethylene-α-olefin copolymer is preferably chosen from the group of α-olefins having 3 to 8 carbon atoms. Examples of suitable-olefins having 3 to 8 carbon atoms include but are not limited to propylene, 1-butene, 1-pentene, 4-methyl-1-pentene, 1-hexen, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

The MFI of the dispersed ethylene α-olefin copolymer (before the heterophasic propylene copolymer is mixed into the composition), MFIrubber, may be for example at least 0.001 dg/min, at least 0.01 dg/min, at least 0.1 dg/min, at least 0.3 dg/min, at least 0.7 dg/min, at least 1 dg/min, and/or for example at most 30 dg/min, at most 20 dg/min, at most 15 dg/min at most 10 dg/min, at most 5 dg/min or at most 3 dg/min. The MFIrubber may be in the range for example from 0.001 to 30 dg/min, for example from 0.01 to 20 dg/min, for example 0.1 to 15 dg/min, for example 0.3 to 10 dg/min, for example from 0.7 to 5 dg/min, for example from 1 to 3 dg/min. MFIrubber is calculated according to the following formula:

$$MFIrubber = {10}^{⋀} ( \frac{Log MFIheterophasic - matrix content * Log MFImatrix}{rubber content} )$$

wherein
MFIheterophasic is the MFI (dg/min) of the heterophasic propylene copolymer measured according to ISO1133 (2.16 kg/230 °C),
MFImatrix is the MFI (dg/min) of the propylene-based matrix measured according to ISO1133 (2.16 kg/230 °C),
matrix content is the fraction of the propylene-based matrix in the heterophasic propylene copolymer,
rubber content is the fraction of the dispersed ethylene-α-olefin copolymer in the heterophasic propylene copolymer. The sum of the matrix content and the rubber content is 1. For the avoidance of any doubt, Log in the formula means log 10.

The dispersed ethylene-α-olefin copolymer is present in an amount of 50 to 5 wt % based on the total heterophasic propylene copolymer. Preferably, the dispersed ethylene-α-olefin copolymer is present in an amount of 40 to 15 wt %, for example in an amount of at least 22 wt % and/or for example in an amount of at most 35 wt % or at most 30 wt % based on the total heterophasic propylene copolymer.

In the heterophasic propylene copolymer in the composition, the sum of the total weight of the propylene-based matrix and the total weight of the dispersed ethylene-α-olefin copolymer is 100 wt % of the heterophasic propylene copolymer.

The α-olefin in the ethylene-α-olefin copolymer is preferably chosen from the group of α-olefins having 3 to 8 carbon atoms and any mixtures thereof, preferably the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

Examples of suitable α-olefins having 3 to 8 carbon atoms, which may be employed as ethylene comonomers to form the ethylene α-olefin copolymer include but are not limited to propylene, 1-butene, 1-pentene, 4-methyl-1-pentene, 1-hexen, 1-heptene and 1-octene.

The elastomer of ethylene and α-olefin comonomer having 4 to 8 carbon atoms may for example have a density in the range from 0.850 to 0.915 g/cm³. Such elastomers are sometimes also referred to as plastomers.

The α-olefin comonomer in the elastomer is preferably an acyclic monoolefin such as 1-butene, 1-pentene, 1-hexene, 1-octene, or 4-methylpentene,

Accordingly, the elastomer is preferably selected from the group consisting of ethylene-1-butene copolymer, ethylene-1-hexene copolymer, ethylene-1-octene copolymer and mixtures thereof, more preferably wherein the elastomer is selected from ethylene-1-octene copolymer. Most preferably, the elastomer is an ethylene-1-octene copolymer.

### Substitute Specification-Clean Version

Preferably, the density of the elastomer is at least 0.865 g/cm³ and/or at most 0.910 g/cm³. For example, the density of the elastomer is at least 0.850, for example at least 0.865, for example at least 0.88, for example at least 0.90 and/or for example at most 0.915, for example at most 0.910, for example at most 0.907, for example at most 0.906 g/cm³. More preferable the density of the elastomer is in the range from 0.88 up to an including 0.907 g/cm³, most preferably, the density of the elastomer is in the range from 0.90 up to and including 0.906 g/cm³.

Elastomers which are suitable for use in the current invention are commercially available for example under the trademark EXACT™ available from Exxon Chemical Company of Houston, Texas or under the trademark ENGAGE™ polymers, a line of metallocene catalyzed plastomers available from Dow Chemical Company of Midland, Michigan or under the trademark TAFMER™ available from MITSUI Chemicals Group of Minato Tokyo or under the trademark Nexlene™ from SK Chemicals.

The elastomers may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The elastomer s may also be prepared using traditional types of heterogeneous multi-sited Ziegler-Natta catalysts.

Preferably, the elastomer has a melt flow index of 0.1 to 40 dg/min (ISO1133, 2.16 kg, 190 °C), for example at least 1 dg/min and/or at most 35 dg/min. More preferably, the elastomer has a melt flow index of at least 1.5 dg/min, for example of at least 2 dg/min, for example of at least 2.5 dg/min, for example of at least 3 dg/min, more preferably at least 5 dg/min and/or preferably at most 30 dg/min, more preferably at most 20 dg/min, more preferably at most 10 dg/min measured in accordance with ISO 1133 using a 2.16 kg weight and at a temperature of 190 °C.

Preferably, the amount of ethylene incorporated into the elastomer is at least 50 mol %. More preferably, the amount of ethylene incorporated into the elastomer is at least 57 mol %, for example at least 60 mol %, at least 65 mol % or at least 70 mol %. Even more preferably, the amount of ethylene incorporated into the elastomer is at least 75 mol %. The amount of ethylene incorporated into the elastomer may typically be at most 97.5 mol %, for example at most 95 mol % or at most 90 mol %.

In preferred embodiments, the thermoplastic polymer in the thermoplastic polymer composition is a propylene homopolymer.

In preferred embodiments, the thermoplastic polymer is a non-visbroken polypropylene, also known as a reactor grade. This results in better smell properties than visborken polypropylene made by visbreaking a reactor grade polypropylene with a lower melt flow index to increase its melt flow index.

### Additives in Thermoplastic Polymer Composition of Polymer Sheath

The thermoplastic polymer composition of the polymer sheath may contain other usual additives, for instance nucleating agents and clarifiers, stabilizers, fillers, plasticizers, anti-oxidants, lubricants, antistatics, scratch resistance agents, impact modifiers, acid scavengers, recycling additives, coupling agents, anti-microbials, anti-fogging additives, slip additives, anti-blocking additives, polymer processing aids, flame retardants, colorants and the like. Such additives are well known in the art. The skilled person will know how to choose the type and amount of additives such that they do not detrimentally influence the aimed properties. The amount of the additives may e.g. be 0.1 to 5.0 wt % of the thermoplastic polymer composition. The amount of the additives may e.g. be 0.1 to 50 wt % of the thermoplastic polymer composition.

In some preferred embodiments, the additives in the thermoplastic polymer composition of the polymer sheath comprises a flame retardant. The flame retardant may comprise an organic flame retardant and/or an inorganic flame retardant.

The organic flame retardant preferably comprises at least one phosphate selected from the group consisting of melamine phosphate, melamine polyphosphate, melamine pyrophosphate, piperazine phosphate, piperazine polyphosphate, piperazine pyrophosphate, 2-methylpiperazine monophosphate, tricresyl phosphate, alkyl phosphates, haloalkyl phosphates, tetraphenyl pyrophosphate, poly(2-hydroxy propylene spirocyclic pentaerythritol bisphosphate) and poly(2,2-dimethylpropylene spirocyclic pentaerythritol bisphosphonate).

The organic flame retardant preferably comprises ammonium polyphosphate. In some preferred embodiments, the organic flame retardant comprises ammonium polyphosphate and at least one of the above-mentioned phosphate.

In some preferred embodiments, the organic flame retardant comprises ammonium polyphosphate and at least two of the above-mentioned phosphate.

In some preferred embodiments, the organic flame retardant comprises ammonium polyphosphate, melamine polyphosphate and piperazine phosphate.

In some preferred embodiments, the organic flame retardant comprises melamine phosphate and piperazine pyrophosphate.

The inorganic flame retardant may comprise e.g. zinc oxide.

In some preferred embodiments, the flame retardant may be particles comprising the organic flame retardant and zinc oxide. Preferably, the amount of zinc oxide with respect to the particles is 1 to 10 wt %.

In some preferred embodiments, the organic flame retardant comprises an aromatic phosphate ester.

In some preferred embodiments, the amount of the flame retardant, in particular the organic flame retardant, with respect to thermoplastic polymer composition of the polymer sheath is 0.1 to 50 wt %, e.g. at least 1.0 wt %, at least 5.0 wt %, at least 10 wt %, at least 20 wt %, at least 30 wt % and/or at most 45 wt % or at most 40 wt %.

The flame retardant described above, in particular the phosphates, may serve as part of an intumescent flame retardant composition. An intumescent flame retardant composition may comprise various components to produce an outer char coating when exposed to flame and/or high heat. A thermoplastic polymer composition comprising an intumescent flame retardant comprises a carbon source and the intumescent flame retardant composition may comprise a film-forming binder, an acid source and a blowing agent. The carbon source can be an organic material that decomposes to a char consisting primarily of carbon when exposed to fire or heat. The carbon source may be the polyolefin in the thermoplastic polymer composition. In the presence of an acid source, which promotes the formation of the char, and a blowing agent, which expands the char, the carbon source can generate an expanded, insulating, cellular structure that can be several times thicker than the original thickness, when exposed to fire or heat.

In some preferred embodiments, the additives in the thermoplastic polymer composition of the polymer sheath comprises a coupling agent.

Suitable examples of the coupling agent include a functionalized polyolefin grafted with an acid or acid anhydride functional group. The polyolefin is preferably polyethylene or polypropylene, more preferably polypropylene. The polypropylene may be a propylene homopolymer or a propylene copolymer. The propylene copolymer may be a propylene-α-olefin copolymer consisting of at least 70 wt % of propylene and up to 30 wt % of α-olefin, for example ethylene, for example consisting of at least 80 wt % of propylene and up to 20 wt % of α-olefin, for example consisting of at least 90 wt % of propylene and up to 10 wt % of α-olefin, based on the total weight of the propylene-based matrix. Preferably, the α-olefin in the propylene-α-olefin copolymer is selected from the group of α-olefins having 2 or 4-10 carbon atoms and is preferably ethylene. Examples of the acid or acid anhydride functional groups include (meth)acrylic acid and maleic anhydride. A particularly suitable material is for example maleic acid functionalized propylene homopolymer (for example Exxelor PO 1020 supplied by ExxonMobil and Fine-Blend® CMG5701 supplied by Fine-Blend Compatibilizer Jiangsu Co., Ltd). In particular maleic acid functionalized propylene homopolymer with low odor and TVOC is preferred, an example being Fine-Blend® CMG5701.

The amount of the coupling agent may e.g. be 0.5 to 3.0 wt %, preferably 1.0 to 2.0 wt %, based on the sheathed continuous multifilament strand.

### Core

The sheathed continuous multifilament strand comprises a core that extends in the longitudinal direction. The core comprises an impregnated continuous bicomponent multifilament strand comprising at least one continuous bicomponent multifilament strand and an impregnating agent. The impregnated continuous bicomponent multifilament strand is prepared from a continuous bicomponent multifilament strand and an impregnating agent by impregnating the continuous bicomponent multifilament strand with the impregnating agent.

Preferably, the total of the impregnated continuous bicomponent multifilament strand and any impregnated continuous glass multifilament strand form at least 90 wt %, more preferably at least 93 wt %, even more preferably at least 95 wt %, even more preferably at least 97 wt %, even more preferably at least 98 wt %, for example at least 99 wt % of the core. In a preferred embodiment, the core consists of the impregnated continuous bicomponent multifilament strand and any impregnated continuous glass multifilament strand.

In the context of the invention with ‘extends in the longitudinal direction’ is meant ‘oriented in the direction of the long axis of the sheathed continuous multifilament strand’

### Continuous Bicomponent Multifilament Strand of Core

The continuous bicomponent multifilament strands comprising the co-filaments are generally supplied as a plurality of continuous, very long filaments, and can be in the form of strands, rovings or yarns. A filament is an individual fibre of reinforcing material. A strand is a plurality of bundled filaments. Yarns are collections of strands, for example strands twisted together. A roving refers to a collection of strands wound into a package.

For purpose of the invention, a multifilament strand is defined as a plurality of bundled co-filaments.

The filament density of the continuous bicomponent multifilament strand may vary within wide limits. For example, the continuous bicomponent multifilament strand may have a density of 1000 to 10000 grams per 1000 meter.

Preferably, the continuous bicomponent multifilament strand has a density of 1000 to 2900 grams per 1000 meter, more preferably 1500 to 2800 grams per 1000 meter.

The continuous bicomponent multifilament strand may have a filament diameter of 5 to 50 μm, more preferably from 10 to 30 μm, even more preferably from 15 to 25 μm. The bicomponent filaments may be circular in cross section meaning the thickness as defined above would mean diameter.

Preferably, the ratio between the length of the bicomponent filament and the diameter of the bicomponent filament (L/D ratio) in the pellets is 500 to 1000.

Preferably, the bicomponent multifilament strand is coated with a sizing composition (i.e., a coating) to improve adhesion to the polymer matrix. The sizing composition can be disposed on substantially all of the bicomponent filaments or on a portion of the bicomponent filaments in the thermoplastic composition. The sizing provides coated bicomponent filaments that can be either bonding or non-bonding towards bicomponent thermoplastic polymer composition of the sheath. Preferably, the coated bicomponent filaments are bonding towards the polymer in the thermoplastic polymer composition of the sheath.

The sizing composition can include a polyepoxide, a poly(meth)acrylate, a poly(arylene ether), a polyurethane, or a combination thereof. The polyepoxide can be a phenolic epoxy resin, an epoxylated carboxylic acid derivative (e.g., a reaction product of an ester of a polycarboxylic acid having one or more unesterified carboxyl groups with a compound including more than one epoxy group), an epoxidized diene polymer, an epoxidized polyene polymer, or a combination thereof.

The sizing composition can further include a silane coupling agent to facilitate bonding with the glass fiber. The silane coupling agent can be tri(C₁₋₆ alkoxy)mono amino silane, tri(C₁₋₆ alkoxy)diamino silane, tri(C₁₋₆ alkoxy)(C₁₋₆ alkyl ureido)silane, tri(C₁₋₆ alkoxy)(epoxy C₁₋₆ alkyl)silane, tri(C₁₋₆ alkoxy)(glycidoxy C₁₋₆ alkyl)silane, tri(C₁₋₆ alkoxy)(mercapto C₁₋₆ alkyl)silane, or a combination thereof. For example, the silane coupling agent is (3-aminopropyl)triethoxy silane, (3-glycidoxypropyl)trimethoxysilane, (2-(3,4-epoxycyclohexyl)ethyl)triethoxysilane, (3-mercaptopropyl)trimethoxysilane, (3-(2-aminoethylamino)propyl)triethoxysilane, (3-ureidopropyl)triethoxy silane, or a combination thereof. Preferably, the silane coupling agent is aminopropyltriethoxysilane, glycidylpropyltrimethoxysilane, or a combination thereof.

Other materials that can be included in the sizing composition include, but are not limited to, anti-static agents, coupling agents, lubricants, wetting agents, or the like.

The sizing composition can be present in an amount from 0.1 to 5.0 wt % based on the weight of the at least one continuous bicomponent multifilament strand. The sizing composition may be applied to the co-filaments by any means, such as immersing the multifilament strand in the sizing composition or contacting the multifilament strand with an aqueous emulsion, or suspension of the sizing composition. Other coating methods include using an aqueous dispersion of the sizing composition applied to the uncoated multifilament strand by a roller in a continuous fashion, which can be followed by a heat treatment or curing step.

Typically, after applying the sizing composition to the filaments, the filaments are bundled into the continuous bicomponent multifilament strands and then wound onto bobbins to form a package.

The above description on the sizing compositions applies both to bi-component filaments and glass filaments.

### Impregnating Agent

The amount of the impregnating agent is preferably in an amount from 0.50 to 18.0 wt %, for example from 0.5 to 10.0 wt % or for example from 10.0 to 18.0 wt % based on the total weight of the pellet.

The optimal amount of impregnating agent depends on the polymer sheath, on the size (diameter) of the filaments forming the continuous strand, and on the type of sizing composition. Typically, the amount of impregnating agent applied to the continuous multifilament strand is for example at least 0.50 wt %, preferably at least 1.0 wt %, preferably at least 1.5 wt %, preferably at least 2 wt %, preferably at least 2.5 wt % and/or at most 10.0 wt %, preferably at most 9.0 wt %, more preferably at most 8.0 wt %, even more preferably at most 7.0 wt %, even more preferably at most 6.0 wt %, even more preferably at most 5.5 wt %, or for example at least 10.0 wt %, preferably at least 11 wt %, preferably at least 12 wt % and/or at most 18 wt %, preferably at most 16 wt %, preferably at most 14% based on the amount of sheathed continuous multifilament strand. Preferably, the amount of impregnating agent is in the range from 1.5 to 8.0 wt %, even more preferably in the range from 2.5 wt % to 6.0 wt % based on the sheathed continuous multifilament strand. A higher amount of impregnating agent increases the Impact Energy per unit of thickness (J/mm). However, for reasons of cost-effectiveness and low emissions (volatile organic compounds) and mechanical properties, the amount of impregnating agent should also not become too high. For example, the ratio of impregnating agent to continuous glass multifilament strand is in the range from 1:4 to 1:30, preferably in the range from 1:5 to 1:20.

Preferably, the viscosity of the impregnating agent is in the range from 2.5 to 200 cSt at 160 °C, more preferably at least 5.0 cSt, more preferably at least 7.0 cSt and/or at most 150.0 cSt, preferably at most 125.0 cSt, preferably at most 100.0 cSt at 160 °C.

An impregnating agent having a viscosity higher than 200 cSt is difficult to apply to the continuous glass multifilament strand. Low viscosity is needed to facilitate good wetting performance of the fibres, but an impregnating agent having a viscosity lower than 2.5 cSt is difficult to handle, e.g., the amount to be applied is difficult to control; and the impregnating agent could become volatile. For purpose of the invention, unless otherwise stated, the viscosity of the impregnating agent is measured in accordance with ASTM D 3236-15 (standard test method for apparent viscosity of hot melt adhesives and coating materials, Brookfield viscometer Model RVDV 2, #27 spindle, 5 r/min) at 160 °C.

Preferably, the melting point of (that is the lowest melting temperature in a melting temperature range) the impregnating agent is at least 20 °C below the melting point of the thermoplastic polymer composition. More preferably, the impregnating agent has a melting point of at least 25 or 30 °C below the melting point of the thermoplastic polymer composition. For instance, when the thermoplastic polymer composition has a melting point of about 160 °C, the melting point of the impregnating agent may be at most about 140 °C.

Suitable impregnating agents are compatible with the thermoplastic polymer to be reinforced, and may even be soluble in said polymer. The skilled man can select suitable combinations based on general knowledge, and may also find such combinations in the art.

Suitable examples of impregnating agents include low molar mass compounds, for example low molar mass oligomeric polyurethanes, polyesters such as unsaturated polyesters, polycaprolactones, polyethyleneterephthalate, poly(alpha-olefins), such as highly branched polyethylenes and polypropylenes, polyamides, such as nylons, and other hydrocarbon resins.

For reinforcing polypropylenes, the impregnating agent preferably comprises highly branched poly(alpha-olefins), such as highly branched polyethylenes, modified low molecular weight polypropylenes, mineral oils, such as, paraffin or silicon and any mixtures of these compounds.

The impregnating agent preferably comprises at least 20 wt %, more preferably at least 30 wt %, more preferably at least 50 wt %, for example at least 99.5 wt %, for example 100 wt % of a branched poly(alpha-olefin), most preferably a branched polyethylene. To allow the impregnating agent to reach a viscosity of from 2.5 to 200 cSt at 160 °C, the branched poly(alpha-olefin) may be mixed with an oil, wherein the oil is chosen from the group consisting of of mineral oils, such as a paraffin oil or silicon oil; hydrocarbon oils; and any mixtures thereof.

Preferably, the impregnating agent is non-volatile, and/or substantially solvent-free. In the context of the present invention, non-volatile means that the impregnating agent has a boiling point or range higher than the temperatures at which the impregnating agent is applied to the continuous multifilament glass strand. In the context of present invention, “substantially solvent-free” means that impregnating agent contains less than 10 wt % of solvent, preferably less than 5 wt % of solvent based on the impregnating agent. In a preferred embodiment, the impregnating agent does not contain any organic solvent.

The impregnating agent may further be mixed with other additives known in the art. Suitable examples include lubricants; antistatic agents; UV stabilizers; plasticizers; surfactants; nucleation agents; antioxidants; pigments; dyes; and adhesion promoters, such as a modified polypropylene having maleated reactive groups; and any combinations thereof, provided the viscosity remains within the desired range. Any method known in the art may be used for applying the impregnating agent to the continuous glass multifilament strand. The application of the impregnating agent may be performed using a die. Other suitable methods for applying the impregnating agent to the continuous multifilament strands include applicators having belts, rollers, and hot melt applicators. Such methods are for example described in documents EP0921919B1, EP0994978B1, EP0397505B1, W02014/053590A1 and references cited therein. The method used should enable application of a constant amount of impregnating agent to the continuous multifilament strand.

The above description on the impregnating agent applies both to bicomponent multifilament strand and glass multifilament strand.

The weight average length of the co-filaments in the pellet or molded article can be determined e.g. by creating a photo image of the pellet or article for allowing an image processing algorithm to detect the length of all the individual filaments in the image and calculating the weigh average length from the detected lengths. A photo image can be created e.g. by incinerating the pellet or article and taking a photo of the ash under an optical microscope. This can be done e.g. by incinerating the pellet or article at a temperature of 700 °C, using a brush to gently spread the ash obtained by incineration and taking a photo under an optical microscope of the spread ash. The individual filament length in the pellet can also be determined by direct measurement of the pellet length.

The weight average length of the co-filaments can be calculated using the following equation:

$${L}_{w} = \frac{\sum {l}_{i}^{2}}{\sum {l}_{i}}$$

wherein L_{w} is the weight average length of the co-filaments, [symbol]
is the individual co-filament length.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### Examples

### Materials Used

GF1: a glass roving having a diameter of 19 micron and a tex of 3000 (tex means grams glass per 1000 m) containing a sizing composition comprising a silane coupling agent.

GF2: a roving having a diameter of 19 micron and a tex of 2200, wherein the roving consists of bundled co-filaments of a basalt filament in contact with an aluminum filament, containing a sizing composition comprising a silane coupling agent and polyurethane

Impregnating agent 1: wax commercially available as IGI Paraflex 4838A

PP1: SABIC PP 595A Polypropylene homopolymer with following properties: density: 905 kg/m³, melt flow index: 45 dg/min at 230 °C and 2.16 kg (test method: ISO1133)

Exxelor PO1020: polypropylene grafted with maleic anhydride from ExxonMobil: density: 900 kg/m³, melting point: 162 °C, melt flow index: 430 dg/min at 230 °C and 2.16 kg (testing method: ASTM D1238)

AOB225: antioxidant B225 from BASF

UV119: UV stabilizer UV 119 from SABO SpA

Pellets of sheathed continuous glass multifilament strands were prepared using components given in Table 1 using the wire coating process as described in details in the examples of WO2009/080281A1.

Impregnating agent 1 was applied to GF1 to obtain an impregnated continuous glass multifilament strand.

Polypropylene and additives shown in table 1 were fed to the extruder to sheath the impregnated continuous glass multifilament strand using an extruder-head wire-coating die. The sheathing step was performed in-line directly after the impregnating step. The obtained sheathed continuous multifilament strand was cut into pellets having length of 8-15 mm and diameter of 3-4 mm. The obtained pellets were molded using ARBURG 320T injection molding machine to prepare the samples for testing.

### Ex 2 and Ex 4

Pellets of sheathed continuous multifilament strands were prepared using components given in Table 1 using the process as in CEx 1.

Following properties were measured and are shown in Table 1.

Flexural performance was tested after 7 days at 23 °C aging according to ISO178.

Tensile performance was tested after 7 days at 23 °C aging according to ISO527.

Charpy performance was tested after 7 days at 23 °C aging according to ISO179/1 eU at 23 °C.

Shielding Dk/Df was tested on molded plaque at 30 to 100 MHz and 100 to 1000 Mhz.

The loss of the strength of the signal as function to frequency was registered.

Weight average filament length of the filaments in an injection molded plaque was determined by heating the sample to collect ash, dispersing the ash residue in a liquid followed by analysis with a microscopy with an imaging software.

TABLE 1

| | Unit | CEx 1 | Ex 2 | CEx3 | Ex4 |
|---|---|---|---|---|---|
| PP1 | wt % | 76.14 | 76.14 | 52.54 | 52.34 |
| Impreg. Agent | wt % | 2.0 | 2.0 | 4.0 | 4.0 |
| GF1 | | 20.1 | | 40.2 | |
| GF2 | wt % | | 20.1 | | 40.2 |
| Exxelor PO 1020 | | 1.5 | 1.5 | 3 | 3 |
| AOB225 | wt % | 0.2 | 0.2 | 0.2 | 0.2 |
| UV 119 | wt % | 0.06 | 0.06 | 0.06 | 0.06 |
| Total | wt % | 100.00 | 100.00 | 100.00 | 100.00 |
| Flexural modulus | MPa | 4582 | 3024 | 8701 | 5199 |
| Flexural stress at break | MPa | 126.7 | 63.5 | 179.6 | 80.5 |
| Tensile modulus | MPa | 4598 | 2707 | 8117 | 4864 |
| Tensile strength | MPa | 79.3 | 33.7 | 110.9 | 45.9 |
| Charpy impact strength | kJ/m² | 20.9 | 11.1 | 50.6 | 14.6 |
| Shielding Dk/Df | % | 0 | −10 | 0 | −25 |
| Weight average filament | mm | 2.5 | 1.9 | 1.5 | 1.5 |
| length Lw | | | | | |

It can be understood that the compositions of Ex 2 and 4 made using long co-filaments of basalt filament and aluminum filament have better shielding properties than the compositions of CEx 1 and CEx 3 made using glass filaments, respectively.

1. A pellet comprising a fiber reinforced thermoplastic polymer composition comprising a thermoplastic polymer and a plurality of co-filaments,
wherein each of the co-filaments comprises a first filament and a second filament, the first filament consisting of an inorganic material, the first filament having a glass transition temperature of greater than or equal to 400 °C, the second filament consisting of a metallic material, and the second filament contacting the first filament,
wherein the weight average length of the co-filaments in the pellet is at least 5.0 mm.

2. The pellet according to claim 1, wherein
the first filament is a glass filament or a basalt filament and
the second filament has an aluminum content of at least 98 wt %.

3. The pellet according to claim 1, wherein the thermoplastic polymer is polypropylene.

4. The pellet according to claim 1, wherein the pellet further comprises a flame retardant.

5. The pellet according to claim 1, wherein filaments in the pellet consist of the co-filaments.

6. The pellet according to claim 1, wherein the pellet further comprises glass filaments, wherein the weight ratio between the co-filaments and the glass filaments is 10:90 to 90:10.

7. The pellet according to claim 1, wherein the pellet comprises a sheathed continuous multifilament strand comprising a core that extends in the longitudinal direction and a polymer sheath which intimately surrounds said core,
wherein the core comprises an impregnated continuous bicomponent multifilament strand comprising at least one continuous bicomponent multifilament strand comprising the plurality of co-filaments which are bundled and
the polymer sheath consists of a thermoplastic polymer composition comprising the thermoplastic polymer.

8. The pellet according to claim 7, wherein the weight average length of the co-filaments in the pellet is substantially the same as the pellet length, and is 10 to 55 mm.

9. The pellet according to claim 1, wherein the plurality of co-filaments are dispersed in a matrix of the thermoplastic polymer.

10. The pellet according to claim 9, wherein the weight average length of the co-filaments in the pellet is substantially the same as the pellet length, and is 5.0 to 10 mm.

11. A molded article made by injection molding of the pellets according to claim 1 and optionally pellets of a thermoplastic composition comprising a thermoplastic polymer and optionally glass filaments, wherein the weight average length of the co-filaments in the article is at least 1.0 mm.

12. A molded article made by extrusion molding of the pellets according to claim 1 and optionally pellets of a thermoplastic composition comprising a thermoplastic polymer and optionally glass filaments, wherein the weight average length of the co-filaments in the article is at least 0.5 mm.

13. The molded article according to claim 11, wherein the molded article is selected from the group consisting of battery housing, battery tray, battery charging station, power tools, building and construction shielding boxes, scaffolding, construction frames and flooring.

14. A process for preparing the pellet according to claim 7, comprising the sequential steps of:
a) unwinding from a package of the at least one continuous bicomponent multifilament strand,
b) applying an impregnating agent to said at least one continuous bicomponent multifilament strand to form the impregnated continuous bicomponent multifilament strand,
c) applying a sheath of thermoplastic polymer around the impregnated continuous multifilament strand to form the sheathed continuous multifilament strand and
d) cutting the strand into the pellets.

15. A process for preparing the pellet according to claim 9, comprising the sequential steps of:
i) unwinding from a package of the at least one continuous bicomponent multifilament strand,
ii) spreading the at least one continuous bicomponent multifilament strand into individual co-filaments,
iii) drawing the co-filaments through a melt of a thermoplastic polymer composition comprising the thermoplastic polymer to impregnate the co-filaments with the thermoplastic polymer to obtain a strand wherein the co-filaments are dispersed in the matrix of the thermoplastic polymer and
iv) cutting the strand to obtain pellets.
